(19) United States
(12) Patent Application Publication
(10) Pub. No.: US 2013/0052612 A1
(43) Pub. Date: Feb. 28, 2013

(54) TOOL FOR THE TREATMENT OF SURFACES OF DENTAL MATERIALS

(71) Applicant: Günter SMAILUS, Agra (CH)

(72) Inventor: Günter SMAILUS, Agra (CH)

(21) Appl. No.: 13/589,567

(22) Filed: Aug. 20, 2012

(30) Foreign Application Priority Data
Aug. 30, 2011 (EP) 11179293.3

(51) Int. Cl. A61C 3/06

(52) U.S. Cl. 433/142

(57) ABSTRACT

The tool for the treatment of surfaces of dental materials comprises a spindle one end of which is provided with an abrasive layer that forms a head and the other end of which is provided with means for connection to a dental handpiece. The end of said spindle on which said abrasive layer is arranged is in the form of a core whose profile is similar to the profile of said abrasive layer, said abrasive layer enclosing said core with the exception of its termination on the handpiece side and having a thickness of at least 0.2 mm. Such a tool is substantially more rupture-proof and allows faster and more precise work.

### BACKGROUND OF THE INVENTION

The present invention relates to a tool for the treatment of surfaces of dental materials, comprising a spindle one end of which is provided with an abrasive layer that forms a head and the other end of which is provided with means for connection to a dental handpiece.

Such tools have existed since over 50 years. The abrasive particles, for example of silicon carbide, are embedded in a silicone-based mixture and the tools are manufactured in different shapes, colors or color codes and sizes, each in different abrasive grades defined by the grain size. The color serves for the identification of the abrasiveness and thus of the type of the treatment, e.g. coarse treatment, polishing, or finishing. In the present text, for the sake of simplicity, reference is only made to polishing, polishing tools, and polishing head, but all treatment phases and the corresponding tools and abrasive layers are also meant to be included.

The newer generation of tools that has been offered since about 10 years has polishing heads whose silicone mixture is provided with diamond particles. In order to economize on the number of diamond particles per tool, polishing heads are being offered where diamond particles are merely embedded in an active zone, i.e. in a zone that is predominantly being utilized and comes into contact with the object being treated, while the remaining, inactive zone contains no particles, as e.g. according to EP-0 972 495 A1. More specifically, the active zone corresponds to the forward or lateral portion of the polishing head, depending on its shape. The abrasiveness of the active zone is color-coded.

The spindles of the polishing tools are mainly made of metal, rarely also of synthetic materials. The polishing head is retained on the spindle by a standard anchorage illustrated in FIG. 1 by way of example.

For an optimum application of the polishing tools, the latter have to meet two requirements simultaneously: On one hand, they have to be resistant since in operation they are subject to high forces and stresses in all directions, but on the other hand, they have to exhibit a certain elasticity or flexibility, respectively, in order to allow full access to the morphology of the tooth being treated.

The polishing tools offered today do not fulfill this twofold requirement. A disadvantage found with these tools is that the active zone of the polishing head, particularly the tip, is frequently and easily broken. Since by definition, at the time of a rupture, a pressure is applied by the polishing head to the material being polished, there is a high probability that the spindle that rotates at a high speed of approx. 5,000 to 15,000 rpm will contact the mentioned material and cause damages such as scratches. In order to reduce the risk of a rupture, the pressure forces applied to the polishing head have to be carefully controlled, which may often prove to be quite difficult in practice whereas it is always very time-consuming if the practitioner wishes to achieve surface polishing of at least sufficient quality.

Moreover, as a consequence of a rupture, the polishing head will suddenly take an undesired and arbitrary shape. This will force the practitioner either to resort to a new tool or, if possible, to continue the current operation and accept further negative consequences, namely that the desired portions of the tooth are insufficiently accessible and furthermore that the polishing quality of the surface portions treated under these circumstances will be quite poor due to the rotary vibrations that are produced. Finally the broken tip may cause problems if it remains in the oral cavity and has to be removed.

To avoid such undesirable ruptures, polishing tools are being offered whose polishing head has a minimum hardness. However, all types of such tools remains affected by disadvantages—even though the risk of a rupture can be expected to diminish—particularly with respect to the quality of the polishing work, the comfort for the patient, and/or the wear resistance and the stability of the tool.

US-2006/269901 A1 discloses a dental tool whose polishing surface is coated with a very thin abrasive layer of 50 nm to 100 μm.

GB-732 124 discloses a hollow dental instrument that is internally and externally coated with abrasive grains, thereby allowing polishing operations both by means of the interior and the exterior.

GB-2 154 487 A discloses a dental tool in whose abrasive layer, which is not specified in more detail, grooves for water cooling are arranged.

U.S. Pat. No. 2,855,673 discloses a dental tool provided with an abrasive layer that is not specified in more detail.

WO-01/03803 discloses a special tool for the preparation of a tooth stump for receiving a crown which tool is provided with an abrasive layer that is not specified in more detail.

### SUMMARY OF THE INVENTION

On the background of this prior art, it is a first object of the invention to provide a tool for the treatment of surfaces of dental materials that has a high breaking strength without sacrificing the other essential advantageous properties. This object is attained by a tool, wherein the end of said spindle on which said abrasive layer is arranged is in the form of a core whose profile is similar to the profile of said abrasive layer, said abrasive layer enclosing said core with the exception of its terminal on the handpiece side and having a thickness of at least 0.2 mm.

Another object of the invention is to provide a tool having a higher polishing power. This object is attained by the tool wherein its abrasive layer has a variable filling degree of abrasive grains, said filling degree being higher at the free end than at the end on the handpiece side.

Based thereon, the features defined in the dependent claims represent particularly advantageous embodiments of the invention.

### BRIEF DESCRIPTION OF THE DRAWINGS

Hereinafter, exemplary embodiments of the invention will be described in more detail with reference to the accompanying drawings.

FIG. 1 schematically shows a tool of the prior art,

FIG. 2 schematically shows a first exemplary embodiment of a tool of the invention having an ogival polishing head,

FIG. 2A shows an exemplary embodiment of a suitable spindle end for the tool of FIG. 2,

FIG. 2B shows a sectional view according to line IIB-IIB in FIG. 2A,

FIG. 3 schematically shows a second exemplary embodiment of a tool of the invention having a cup-shaped polishing head,

FIG. 3A shows an exemplary embodiment of a suitable spindle end for the tool of FIG. 3,

FIG. 3B shows a sectional view according to line IIIB-IIIB in FIG. 3A,

FIG. 4 shows a schematic sectional view of another exemplary embodiment of a tool of the invention having a disk-shaped polishing head,

FIG. 5 schematically shows another exemplary embodiment of a tool of the invention having the shape of a rod with a rounded end, and

FIG. 6 schematically shows another exemplary embodiment of a tool of the invention having the shape of a rod with a parallelepipedic end.

### DETAILED DESCRIPTION OF THE INVENTION

Basically, the heads of the rotating tools substantially have an elongated or a planar shape. Their shapes are optimized in view of their application and may e.g. be cylindrical, conical, ogival, frustoconical, disk-shaped or mushroom-shaped.

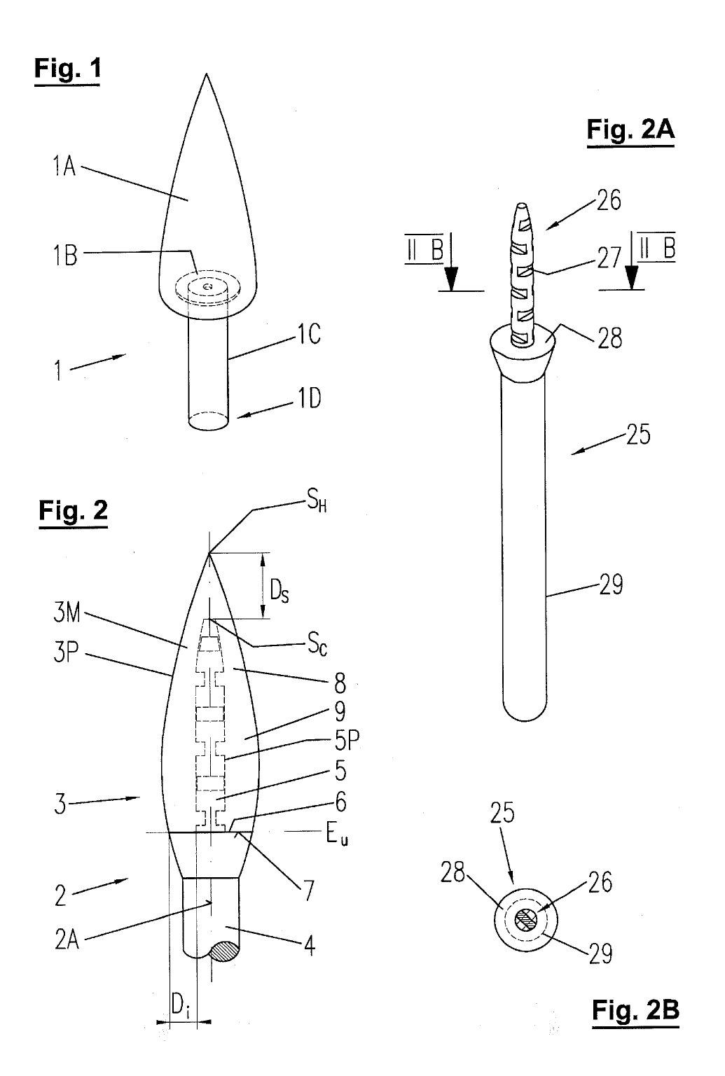

FIG. 1 illustrates a polishing tool 1 of the prior art and shows an ogival head 1A in which the disk-shaped end 1B of spindle 1C is represented in dashed lines, whereby the risk of a rupture becomes apparent. The handpiece end 1D of the spindle is shaped for being inserted into the dentist's handpiece, however, different connecting parts that are known per se are possible for all examples.

FIG. 2 shows in a first exemplary embodiment of the invention a polishing tool 2 that is rotatable about a rotation axis 2A and has an ogival polishing head 3 according to the profile 3P. The term “profile” here refers to the surface or contour, respectively. This polishing head 3 is anchored at the end portion 5 of a spindle 4 while the invisible opposite end portion of the spindle is shaped for being introduced into a handpiece.

The end portion that has the function of an anchorage forms a core 5 with a shoulder 6 while the shape of the profile 5P of this core, which is illustrated in dashed lines in FIG. 2, is similar to the shape of profile 3P of polishing head 3, i.e. also ogival according to the example. The rigid anchorage 5 is entirely enclosed by the active portion of the polishing head except for shoulder 6, which may remain visible. The lower surface 7 of polishing head 3 and shoulder 6 extend in the same plane Eᵤ here.

Between profile 5P of core 5 and profile 3P of polishing head 3 a distance Dᵢ results that corresponds to the thickness of the abrasive layer and may either be constant or variable as in the example of FIG. 2. By convention, the distance Dᵢ is the distance measured in any plane that is perpendicular to axis 2A. In this exemplary embodiment, this distance varies continuously. The distance Dₛ between apex S_{c} of core 5 and apex S_{H} of polishing head 3 geometrically results from the ogival or paraboloidal shapes of core 5 and of polishing head 3.

Constructively, Dᵢ is derived based on certain data such as the type of treatment for which the polishing tool is intended, respectively the grain size of the abrasive particles embedded in the elastic composition forming the polishing head, the strength required to exclude any rupture, the desired elasticity and flexibility of the polishing head relative to the density of the abrasive particles. Furthermore, the layer thickness of the abrasive portion will be a function of whether the tool is intended for single use or for multiple use. Thus, for example, the layer may have a thickness of 0.2 to 2 mm for single use and a thickness of 2 mm and more multiple use. Preferred is a thickness of 0.3 to 1 mm for single use and a thickness of 2 mm and more for multiple use.

The abrasive layer 3M, an elastic composition such as silicone or another suitable, relatively soft synthetic material, e.g. PTE, provided with abrasive particles, e.g. diamond particles, is applied to the rigid core by means of methods that are known per se. In order to improve the bond between the core e.g. of metal or a synthetic material, it is advantageous to structure the surface of the core. FIGS. 2, 2A show an example of a structured core where the surface 26 of core 25 is provided with incisions 27. In this exemplary embodiment, spindle 29 has a shoulder 28 facing towards the tool end, like shoulder 6 in FIG. 2. FIG. 2B shows a sectional view according to line IIB-IIB in FIG. 2A, viewed from below.

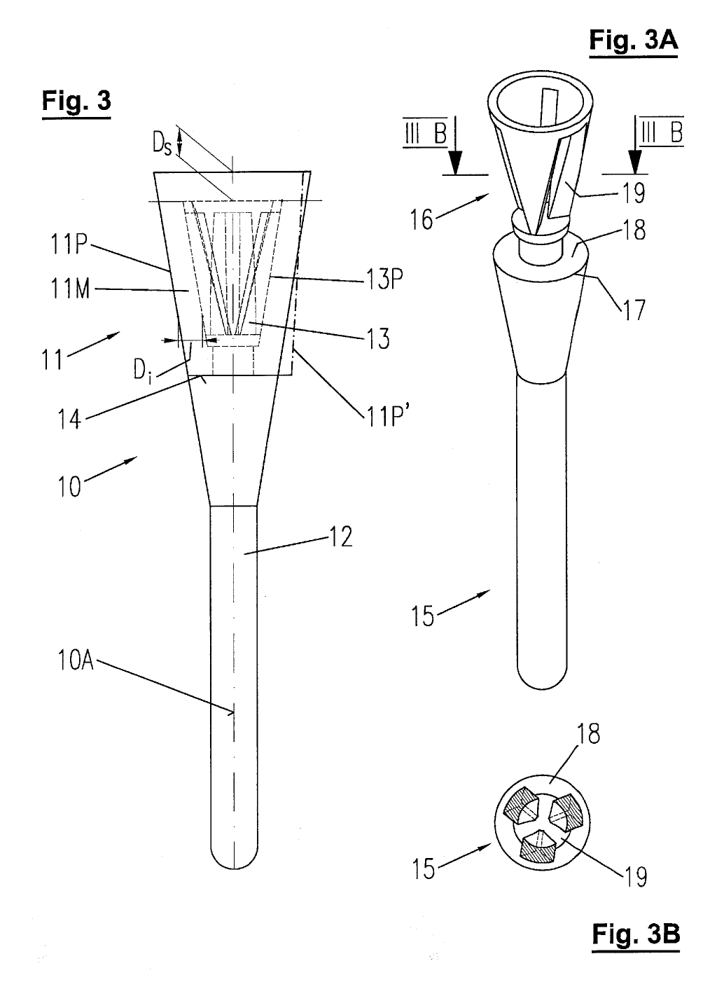

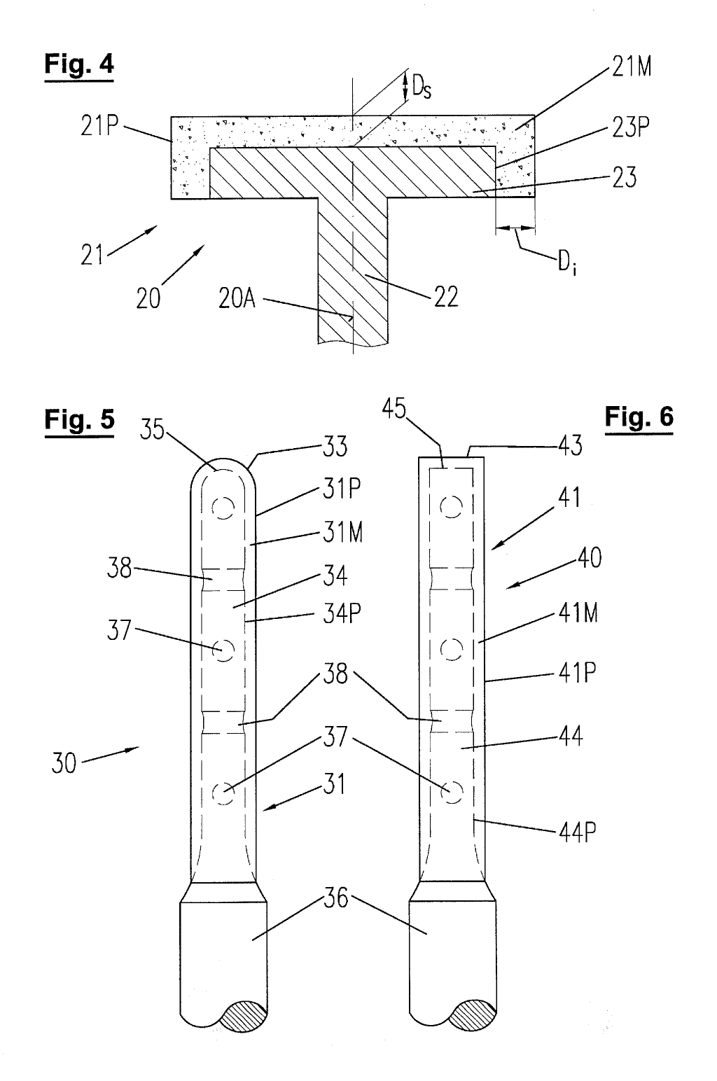

FIG. 3 and FIG. 4 show further possible embodiments of rotating polishing tools 10; 20. Their respective descriptions correspond to the above description of FIG. 2. FIG. 3 illustrates a tool 10 with rotational axis 10A and a frustoconical polishing head 11 in the shape of a cup that enlarges towards the tool end. The profile 13P of core 13 corresponds to the profile 11P of the abrasive layer 11M. In the present exemplary embodiment, abrasive layer 11M, or the distance Dᵢ between core profile 13P and layer profile 11P, respectively, is constant. Of course, this distance may also be variable. While the core has no shoulder in this embodiment, a shoulder 14 for the abrasive layer results.

Alternatively, the frustoconical polishing head and core may taper towards the tool end and may be solid.

FIG. 3A illustrates a possible structured spindle 15 with core 16 where in analogy to FIG. 2A the spindle comprises a shoulder 17 whose surface 18 is facing towards the tool end. Core 16 is shaped as a conical cup, i.e. it is internally hollow, and has slots 19 serving for a better anchorage of the abrasive layer. Instead of continuous slots, a large number of indentations, grooves, and the like are possible. Furthermore, due to the conicity, a better anchorage of the polishing composition is achieved, particularly during the treatment. FIG. 3B is a sectional view according to line IIIB-IIIB in FIG. 3A in the viewing direction towards the handpiece end.

FIG. 4 shows a polishing tool 20 with a spindle 22 that is provided with a disk-shaped core 23 having a profile 23P and a disk-shaped polishing head 21 having an analogous profile 21P. The distance Dᵢ between these profiles, i.e. the abrasive layer 21M, is generally constant in this embodiment but may possibly be variable too. 20A denotes the axis of rotation. The core may again be structured in order to achieve a better anchorage of the abrasive layer.

FIGS. 5 and 6 show further exemplary embodiments of a tool 30 or 40 for the treatment of dental surfaces. In FIG. 5, tool 30 has a head 31 in the shape of a rod comprising an abrasive layer 31M having a profile 31P with a rounded front part 33 and a corresponding core 34 having a profile 34P also with a rounded front part 35. The core is made in one piece with spindle 36. The abrasive layer may have a constant or variable thickness. For a better anchorage of the abrasive layer, the core is provided with bores 37 and 38 whereas transverse ridges may also be used. The bores may be blind holes or through-going bores.

In the variant according to FIG. 6, the head 41 of tool 40 is also in the form of a rod but both the abrasive layer 41M with profile 41P and core 44 with profile 44P have a parallelepipedic profile 43 respectively 45 at their front ends 43 respectively 45. Here also, for a better anchorage of the abrasive layer, the core is provided with bores 37 and 38 whereas transverse ridges may also be used. The bores may be blind holes or through-going bores.

Due to the fact that the core has approximately the same profile as the abrasive layer, it is possible to optimally adapt the distribution of the abrasive grains, i.e. the filling degree, to the working conditions. Advantageously, for front part 8, see FIG. 2, a higher content of diamond particles is used at the tool tip than in rear part 9. This results in a higher abrasive power in those locations where the most intense work is done. This allows faster and also more precise work.

The distribution of the diamond particles, or the boundary between the forward and the rear parts, respectively, is different depending on the intended application and the embedding masses and abrasive grains that are used, and may be adapted to any situation. For example, the volume ratio of the front part to the rear part may be ⅓ to ⅔, and the filling degree may vary between 80% at the forward end and 10% in the rear part.

Accordingly, the anchorage or the core, respectively, fulfills its primary function thanks to its shape relative to the external shape of the polishing head and thanks to the fact that the core forms a monolithic unit with spindle 4. At the same time, the core whose profile is similar to that of the abrasive layer has an economical significance since it provides the optimum solution regarding the minimization of the mass of the abrasive layer and thus of the diamond particles and of the polishing head.

Providing a core that is adapted to the desired profile of the abrasive head is not limited to the indicated exemplary shapes but can be applied to all known and still other shapes. The configuration of the structurings of the core is not limited to the depicted examples either. A large number of recesses, elevations, or slots are possible. The most diverse application possibilities also apply to the materials to be used both for the core and for the abrasive layer.

What is claimed is:

1. A tool for the treatment of surfaces of dental materials, comprising a spindle one end of which is provided with an abrasive layer that forms a head and the other end of which is provided with means for connection to a dental handpiece, wherein the end of said spindle on which said abrasive layer is arranged is in the form of a core whose profile is similar to the profile of said abrasive layer, said abrasive layer enclosing said core with the exception of its terminal on the handpiece side and having a thickness of at least 0.2 mm.

2. The tool of claim 1, wherein the thickness of said layer is 0.2 mm to 2.0 mm for single use and more than 2 mm for multiple use.

3. The tool of claim 2, wherein the thickness of said layer is 0.3 mm to 1.5 mm for single use and more than 2 mm for multiple use.

4. The tool of claim 1, wherein the profile of said head and the profile of said core are ogival.

5. The tool of claim 1, wherein the profile of said head and the profile of said core are frustoconical and the truncated cone enlarges towards the free end.

6. The tool of claim 1, wherein the profile of said head and the profile of said core are frustoconical and the truncated cone tapers towards the free end.

7. The tool of claim 1, wherein the core is cup-shaped.

8. The tool of claim 1, wherein the profile of said head and the profile of said core are disk-shaped.

9. The tool of claim 1, wherein the profile of said head and the profile of said core are both in the shape of a rod having a rounded free end.

10. The tool of claim 1, wherein the profile of said head and the profile of said core are both in the shape of a rod having a parallelepipedic free end.

11. The tool of claim 1, wherein the thickness of said abrasive layer is constant.

12. The tool of claim 1, wherein the thickness of said abrasive layer is variable and diminishes towards the tip.

13. The tool of claim 1, wherein the surface of said core is provided with means serving for a better anchorage of said abrasive layer.

14. The tool of claim 1, wherein said abrasive layer has a variable filling degree of abrasive grains, said filling degree being higher at the free end than at the end on the handpiece side.

15. The tool of claim 1, wherein said abrasive layer comprises an elastic composition such as silicone or a soft synthetic material, in which abrasive particles such as diamond particles are embedded.
